(19) United States
(12) Patent Application Publication
(10) Pub. No.: US 2009/0311917 A1
(43) Pub. Date: Dec. 17, 2009

(54) Socket for Bulb

(75) Inventor: Sun Chul Kim, Gangdong-gu (KR)

Correspondence Address: AKERMAN SENTERFITT, 8100 BOONE BOULEVARD, SUITE 700, VIENNA, VA, 22182-2683, US

(73) Assignee: SHIN KWANG HI TECH CO., LTD., Gimpo-city, Gyeonggi-do (KR)

(21) Appl. No.: 12/223,457

(22) PCT Filed: Mar. 2, 2007
(86) PCT No.: PCT/KR2007/001060

§ 371 Date: Apr. 15, 2009

(30) Foreign Application Priority Data
Apr. 14, 2006 (KR) 10-2006-0034014
Jun. 21, 2006 (KR) 10-2006-0056044

(51) Int. Cl. H01R 24/00

(52) U.S. Cl. 439/699.2

(57) ABSTRACT

An electric bulb socket is provided, which includes a socket body (100) (300) in the upper surface of which a recessed groove (101) (301) is formed, and a connection unit (200) (400) which is inserted into and fixed to the recessed groove (101) (301), and is provided with at least one entrance portion (201)(401), in which elastic pieces (230) (430) are arranged and fixed in inner spaces (203) (403) thereof and fixed conductive pieces (240) (440) respectively corresponding to the elastic pieces (230) (430) are arranged and fixed in the recessed groove (101) (301), so as to be integrally combined with the socket body (100) (300). Begun contents are thing about light bulb socket that insertion juncture of bare wire is simple. The electric bulb socket provides a stable electric power connection of bare wires, simplifies an assembly thereof and enables an electric appliance to be safely grounded.

### TECHNICAL FIELD

The present invention relates to a socket for an electric bulb, and more particularly, to an electric bulb socket in which a connection unit with which bare wires are inserted and electrically connected is coupled with a socket body to thus simplify insertion and connection of bare wires.

### BACKGROUND ART

In general, an electric bulb socket includes a screw socket for a first terminal and a terminal pieces for a second terminal at the inner side of a cylindrical body. The electric bulb socket has a connection structure in which electric wires are connected at the rear end thereof, in which the screw socket and the terminal pieces are connected with eyelets, etc. The electric bulb socket having the above-described assembly structure is used as a lighting fixture which is installed on the ceiling together with a lamp shade.

It is common that the socket for lighting is coupled with bolt members which are rivetted from the inner portion of a socket body at the rear end thereof in order to fix electric wires.

There is an electric bulb socket disclosed in Korean registration utility model 20-0404097 (Dec. 12, 2005) as an example of the electric bulb socket. As shown in FIG. 1, the combination/connection structure with a light bulb is provided at the inner side of a cylindrical socket body medial of a ceramic material, and a structure of connecting electric wires is provided at the outer-rear end thereof.

In the case of the electric wire connection structure, the end portion of the coated electric wire is peeled off to make the bare wire exposed, and then the exposed bare wire is made into a ring shape and wound around a bolt member so as to be tightly connected with each other, or welded or soldered between the exposed bare wire and the bolt member. Accordingly, the electric power connection may be unstable or the working time may be delayed in the case that the electric bulb socket is installed on a wall or ceiling.

The problem of the conventional light bulb socket is due to the face that a connection structure of a portion which is connected at the rear end of a socket at the state of bare wires is unstable. Accordingly, the connection structure of a portion which is connected at the rear end of a socket at the state of bare wires need to be improved into a stable electrification structure.

### DISCLOSURE OF INVENTION

### Technical Problem

Therefore, in order to supplement the shortcoming of the conventional art, it is an object of the present invention to provide a new electric bulb socket in which a connection unit with which bare wires are inserted and electrically connected is coupled with a socket body to thus simplify insertion and connection of bare wires, considering a stable connection structure of the electric bulb socket.

It is another object of the present invention to provide an electric bulb socket which enables a more stable electric power supply and makes an assembly work of the electric bulb socket convenienced, in addition to a simple wire connection structure. Technical Solution

To accomplish the above object of the present invention, there is provided an electric bulb socket comprising: a socket body in which a fixed conductive piece having a locking piece is installed; and a connection unit which is provided with an entrance portion through which bare wires are inserted and connected, where the lower portion of the connection unit is opened, and an elastic piece is inserted and supported in the inner side space of the connection unit, and with a locking groove by which the locking piece of the fixed conductive piece is locked so as to be inserted and attached therein in correspondence to the elastic piece, wherein the socket body and the connection unit are integrally combined with each other.

Preferably but not necessarily, the socket body has a recessed groove with which the connection unit is combined on the cylindrical outer-upper end portion, and fixing holes through which eyelets are penetrated on the bottom side thereof.

Preferably but not necessarily, the connection unit is provided with an engagement protrusion having an engagement hole, and the socket body is provided with an engagement hole which is communicated with the engagement protrusion in which the engagement protrusion and the engagement hole are engaged by a screw bolt.

Preferably but not necessarily, the connection unit further comprises locking elastic pieces for coupling a lamp shade at a certain position of the outer side thereof.

Preferably but not necessarily, the recessed groove of the socket body further comprises a seating groove in which the engagement protrusion is seated.

Preferably but not necessarily, the connection unit is provided with two spaces which are separately formed and the lower portion of which is opened, in which locking grooves are formed in the inner wall of each space and an entrance portion is formed in the upper surface of each space to communicate with each space, and locking elastic pieces which prevent the engagement protrusion from seceding at the time of combining the engagement protrusion having the engagement hole on the perpendicular planes of either side of the outer broad width is formed in parallel with the engagement protrusion, in which the engagement protrusion and the locking elastic pieces are formed in parallel with each other in symmetry with the opposing perpendicular plane and the seating groove of the socket body is symmetrically formed in correspondence to the locking elastic pieces.

Preferably but not necessarily, a locking portion is slantingly formed in the upper portion of the elastic piece so that the bare wires are inserted and locked, a secession prevention locking piece is formed on the perpendicular plane thereof, and a right angle plane is formed in the lower portion thereof.

Preferably but not necessarily, the fixed conductive piece is formed of an L-shaped form in which a locking piece is formed on the perpendicular plane thereof, and fixing holes are formed in the lower portion thereof which is bent at right angle.

Preferably but not necessarily, the space of the socket body is spirally formed in order to screw-connect with the base of the electric bulb socket in which an engagement hole, a screw socket in which fixing holes are drilled and a terminal piece are formed on the inner bottom side of the electric bulb socket.

### ADVANTAGEOUS EFFECTS

The present invention provides a new electric bulb socket in which a connection unit with which bare wires are inserted and electrically connected is coupled with a socket body to thus simplify insertion and connection of bare wires, and which enables a more stable electric power supply and makes an assembly work of the electric bulb socket convenienced, in addition to a simple wire connection structure.

### BRIEF DESCRIPTION OF THE DRAWINGS

FIG. 1 is a perspective view showing a disassembled state of a conventional electric bulb socket;

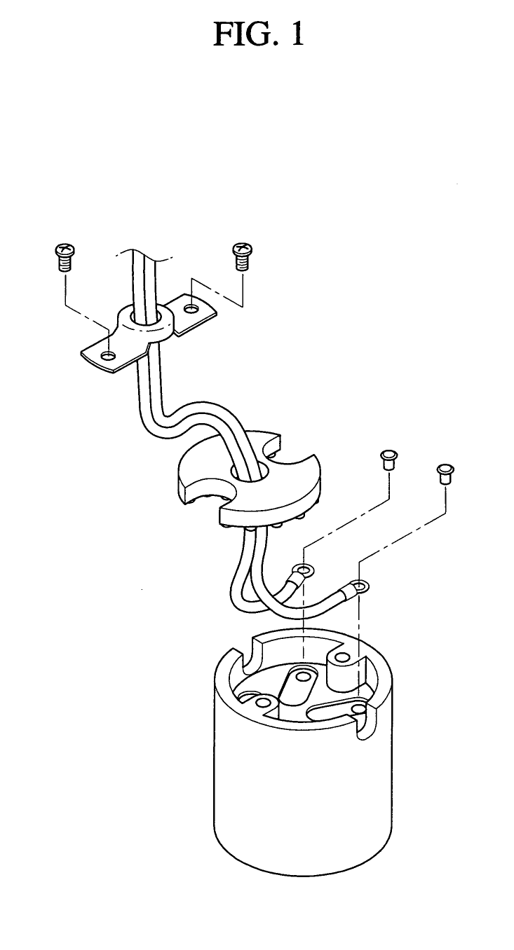

FIG. 2 is a perspective view showing an assembled state of an electric bulb socket according to the present invention;

FIG. 3 is an exploded perspective view showing an electric bulb socket according to the present invention;

FIG. 4 is an exploded cross-sectional view showing an electric bulb socket according to the present invention;

FIGS. 5A and 5B are cross-sectional views showing an assembled state of an electric bulb socket according to the present invention, respectively;

FIG. 6 is a cross-sectional view showing an electric bulb socket with which a lamp shade is combined according to the present invention;

FIG. 7 is a perspective view showing an electric bulb socket according to a second exemplary embodiment of the present invention;

FIG. 8 is a perspective view showing a disassembled state of an electric bulb socket according to the second exemplary embodiment of the present invention;

FIGS. 9A through 9C are a cross-sectional view, a plan view and a bottom view of a connection unit of an electric bulb socket according to the present invention, respectively;

FIGS. 10A and 10B are a bottom view and a plan view showing a socket body of an electric bulb socket according to the present invention, respectively; and

FIGS. 11A and 11B are cross-sectional views showing an electric bulb socket according to the present invention, respectively. Best Mode for Carrying Out the Invention

The present invention provides an electric bulb socket comprising: a socket body in the upper surface of which a recessed groove is formed; and a connection unit which is inserted into and fixed to the recessed groove, and is provided with at least one entrance portion, in which an elastic piece is arranged and fixed in the inner space thereof and a fixed conductive piece corresponding to the elastic piece is arranged and fixed in the recessed groove, so as to be integrally combined with the socket body.

### MODE FOR THE INVENTION

Hereinbelow, an electric bulb socket according to a preferred embodiment of the present invention will be described in more detail with reference to the accompanying drawings.

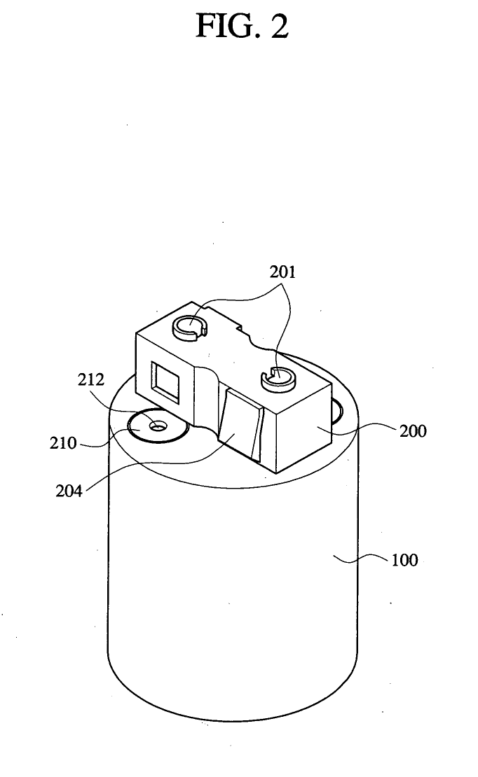

FIG. 2 is a perspective view showing an assembled state of an electric bulb socket according to the present invention.

Referring to FIG. 2, an electric bulb socket according to the present invention includes a socket body 100 and a connection unit 200 largely.

The connection unit 200 which combined with the rear end portion of the socket body 100 has an entrance portion 201 at the top portion thereof. The connection unit 200 includes an engagement protrusion 210 provided with a first engagement hole 212 at the state of being combined with the socket body 100, and locking elastic pieces 204.

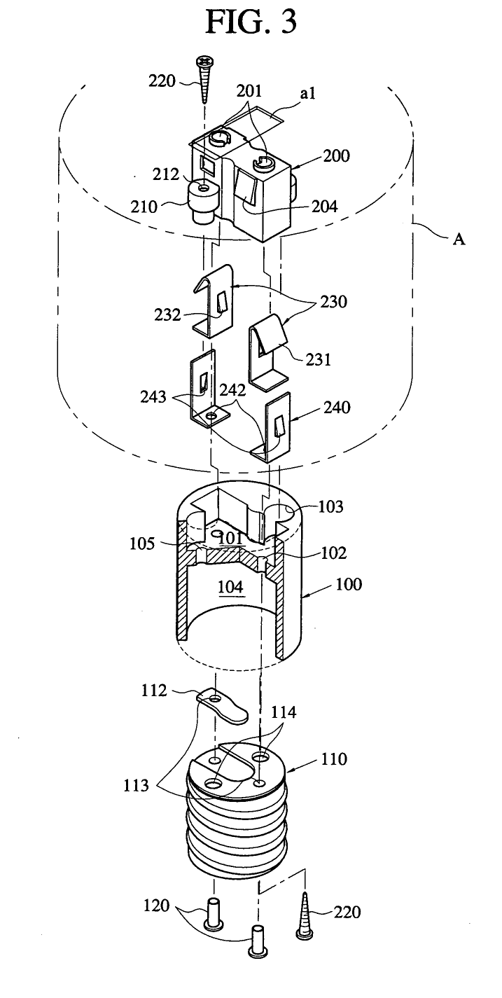

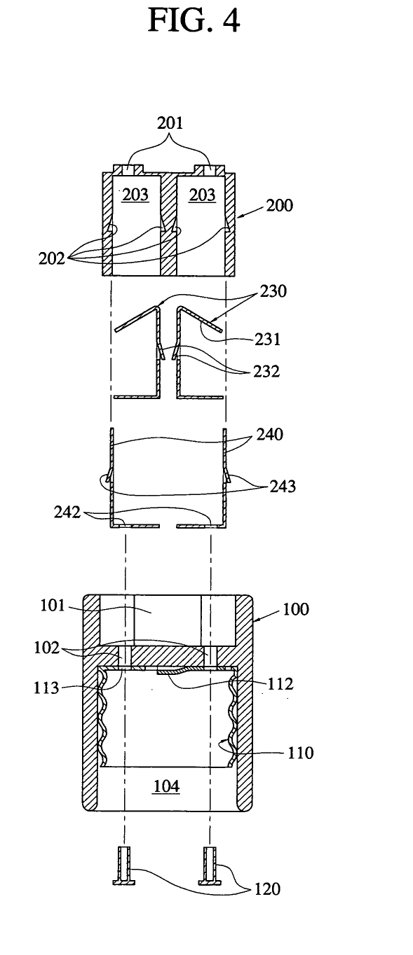

FIG. 3 is an exploded perspective view showing an electric bulb socket according to the present invention, and FIG. 4 is an exploded cross-sectional view showing an electric bulb socket according to the present invention.

Referring to FIGS. 3 and 4, the electric bulb socket according to the present invention will be described in detail.

The socket body 100 is provided with a recessed groove 101 having a substantially rectangular recess which is combined with the connection unit 200 at the rear end of a cylindrical outer side thereof. Second fixing holes 102 and second engagement holes 105 are perforated on the bottom of the recessed groove 101 to communicate with the space 104 in the socket body 100.

Seating grooves 103 are symmetrically formed in the recessed groove 101, and are semicircularly inserted into the recessed groove 101 of a rectangular form. The second fixing holes 102 are holes which are perforated at the time of fixing eyelets 120 to be described later, and the second engagement holes 105 are holes with which screw bolts 220 are engaged.

A screw socket 110 is formed of a substantially cylindrical shape, and third fixing holes 113 and third engagement holes 114 are formed in the inner-bottom portion of the screw socket 110. A part of the bottom of the screw socket 110 is opened so that terminal pieces 112 of respectively different polarities are located, and the main wall of the screw socket 110 is spirally formed. The screw socket 110 is inserted into the space 104 of the socket body 100 and fixed with eyelets 120.

That is, the eyelets 120 are made to pass through the third fixing holes 113 of the socket body 100 and to pass through the second fixing holes 102 in the socket body 100 to then pass through the first fixing holes 242 of the fixed conductive piece 240 to be described later, and has an assembly structure that the eyelets 120 are compressed and bent between the holes 113, 120, and 242.

The connection unit 200 is provided with two spaces 203 which are separately formed and the lower portion of which is opened, in which locking grooves 202 which are opposed to each other at a substantially identical position and are inclined downwards are formed in the inner wall of each space and an entrance portion 201 is formed in the upper surface of each space 203 to communicate with each space 203, and locking elastic pieces 204 which are respectively provided with an engagement protrusion 210 formed of a first engagement hole 212 and prevent the engagement protrusions 210 from seceding at the time of assembling a lamp shade “A” on the perpendicular planes of either side of the outer broad width is formed in parallel with the engagement protrusion.

The engagement protrusion 210 and the locking elastic pieces 204 which are formed on either side perpendicular plane are symmetrically located in the lower portions of the respectively opposing perpendicular planes around the central portion of the connection unit 200.

The elastic pieces 230 are inserted and supported in the space 203 of the connection unit 200, so that the bare wires “a” are inserted and locked into the space 203.

That is, locking portions 231 for compression of the bare wires are formed in the upper portion of the connection unit 200, and secession prevention pieces 232 are bent and formed on the perpendicular plane thereof, in which the right angle plane which is horizontally bent is formed in the lower portion thereof.

The elastic pieces 230 are also locked into the locking grooves 202 by the locking pieces 232, to thus prevent secession from the connection unit 200. The bare wires which have passed through the entrance portion 201 are prevented from be seceded by the locking portion 231 (in correspondingly contact with the fixed conductive pieces 240), to simultaneously thereby achieve conduction and connection of electric power.

The fixed conductive pieces 240 are formed of an L-shaped form, respectively, in which locking pieces 243 are formed on the perpendicular plane thereof, and first fixing holes 242 are formed in the lower portion thereof which is bent at right angle. The fixed conductive pieces 240 are vertically fixed to the socket body 100, by the eyelets 120 having passed through the second fixing holes 102 of the socket body 100 and third fixing holes 113 of the screw socket 110.

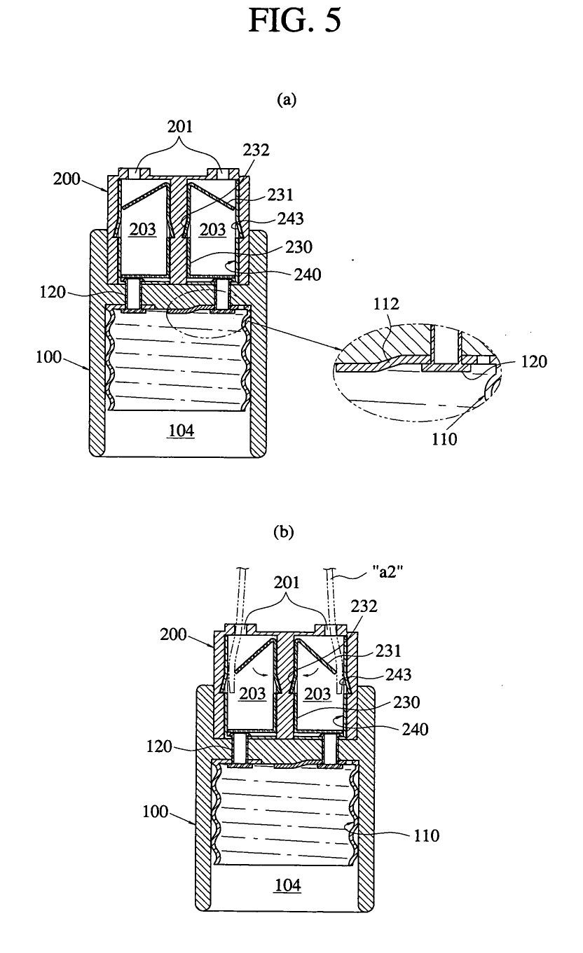

FIGS. 5A and 5B are cross-sectional views showing an assembled state of an electric bulb socket according to the present invention, respectively. An assembly of the electric bulb socket according to the present invention will be described as follows.

As shown in FIG. 3, the screw socket 110 and a terminal piece 112 are located in the lower space 104 of the socket body 100. The fixed conductive pieces 240 are located in the outer upper portion thereof, and then are fixed to the screw socket 110 and the terminal pieces 112 through the eyelets 120 from the lower portion of the socket body 100.

Here, the eyelets 120 pass through the third fixing holes 113, the second fixing holes 102, and the first fixing holes 242 in the fixed conductive piece 240 located on the bottom of the space 101 in turn, and then the top portions of the eyelets 120 protruded into the first fixing holes 242 are compressed to fix the eyelets 120.

Meanwhile, the connection unit 200 is provided with the locking portion 231 in the spaces 203. In addition, the elastic pieces 230 provided with the secession prevention locking pieces 232 formed of respective perpendicular planes are inserted into the spaces 203, and attached and supported thereto, so that the locking pieces 232 are locked into the locking grooves 202 in both sides of the central horizontal wall of the connection unit 200.

Likewise, if the internal assemblies of both the socket body 100 and the connection unit 200 are ended, the connection unit 200 is inserted into the upper space 101 of the socket body 100 to make the connection unit 200 combined with the socket body 100.

Here, the locking pieces 243 of the fixed conductive pieces 240 are inserted into and then locked by the empty locking grooves 202 in the spaces 203 of the connection unit 200. As a result, since the connection unit 200 and the fixed conductive pieces 240 are linked to each other in an integrated form, the socket body 100 and the connection unit 200 are integrally combined with each other.

In this way, the elastic pieces 230 and the fixed conductive pieces 240 are located face to face in each space 203, the bare wires “a” are inserted and closely attached to and supported by each other between the locking portion 231 and the fixed conductive pieces 240.

In particular, in the case of the electric bulb socket according to the present invention, in order to reinforce coherence of the socket body 100 integrated with the connection unit 200, one screw bolt 220 is inserted along the third engagement hole 114 and the second engagement hole 105 of the screw socket 110 in turn from the bottom of the socket body 100, and then is combined with the first engagement hole 212 of the engagement protrusion 210 in the connection unit 200, to thus combine the connection unit 200 and the socket body 100 more strongly.

Thereafter, in order to combine the electric bulb socket with a lamp shade “A”, the other screw bolt 220 is engaged with and fixed to first and second engagement holes 212 and 105, through a hole which is formed on the lamp shade “A”. Accordingly, the present invention provides a socket coupling structure integrated with the lamp shade “A”.

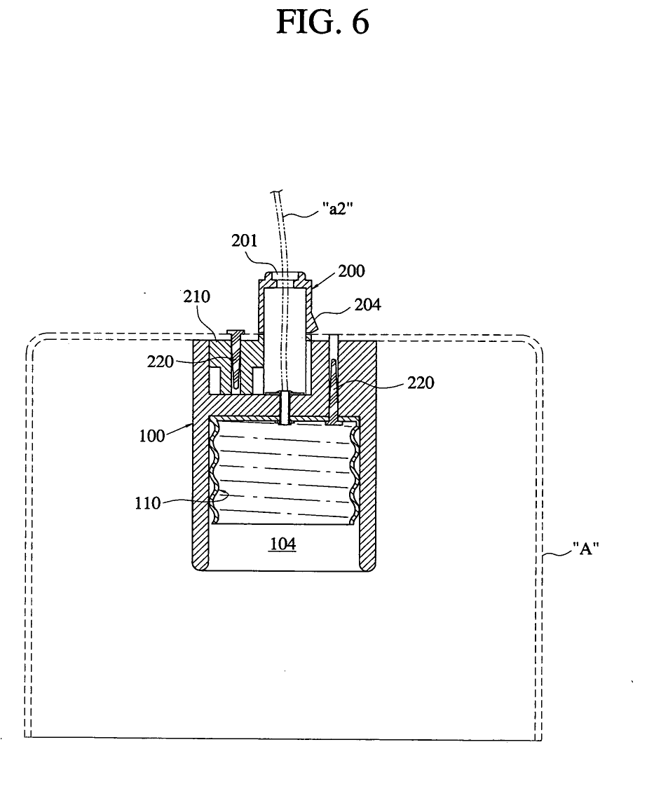

FIG. 6 is a cross-sectional view showing an electric bulb socket with which a lamp shade is combined according to the present invention.

The function of the electric bulb socket according to the present invention will be described with reference to FIGS. 5A, 5B and 6.

As illustrated in FIGS. 5A, 5B and 6, bare wires “a” are inserted into the entrance portion 201 to then be inserted and supported between the fixed conductive pieces 240 and the locking portions 231 of the elastic pieces 230. Accordingly, an electric power supply voltage can be applied along the fixed conductive pieces 240. The electric power supply voltage applied through the fixed conductive pieces 240 is applied to the screw socket 110 and the terminal pieces 112 through the eyelets 120 to thus electrify the same, and accordingly supply an electric power voltage to an electric bulb which is screw-engaged with the electric bulb socket.

An electric bulb socket according to a second exemplary embodiment of the present invention will be described with reference to the accompanying drawings.

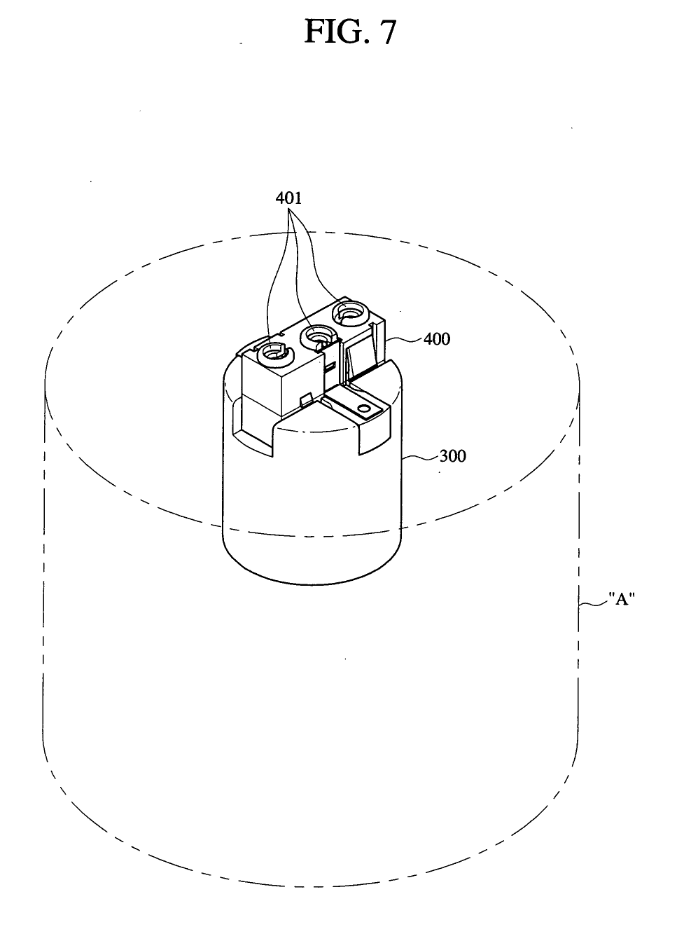

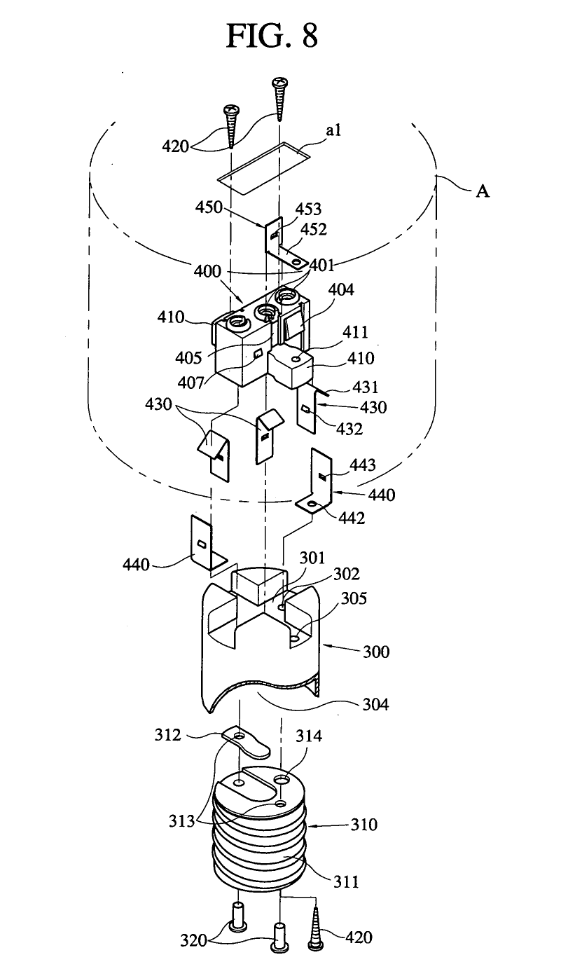

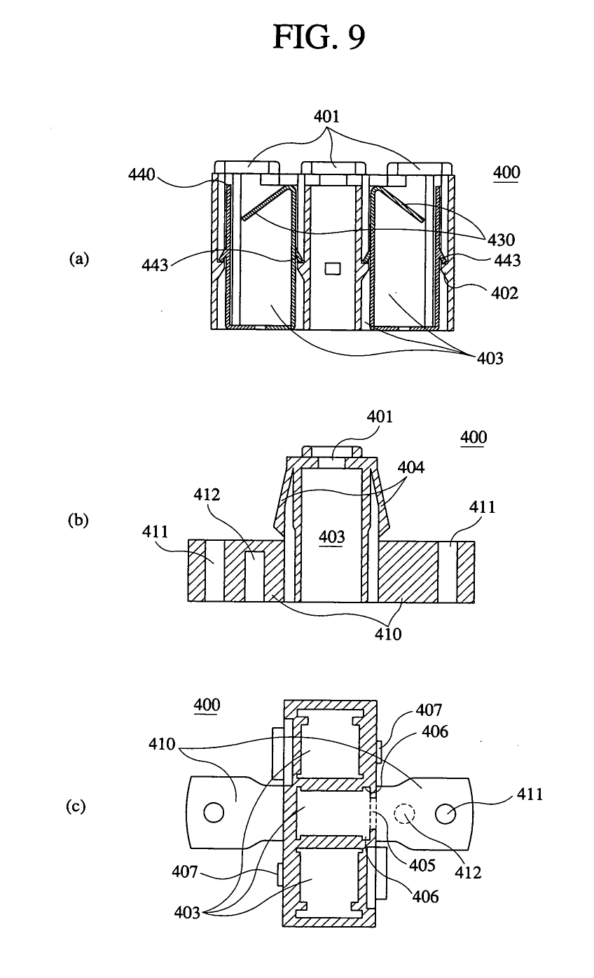

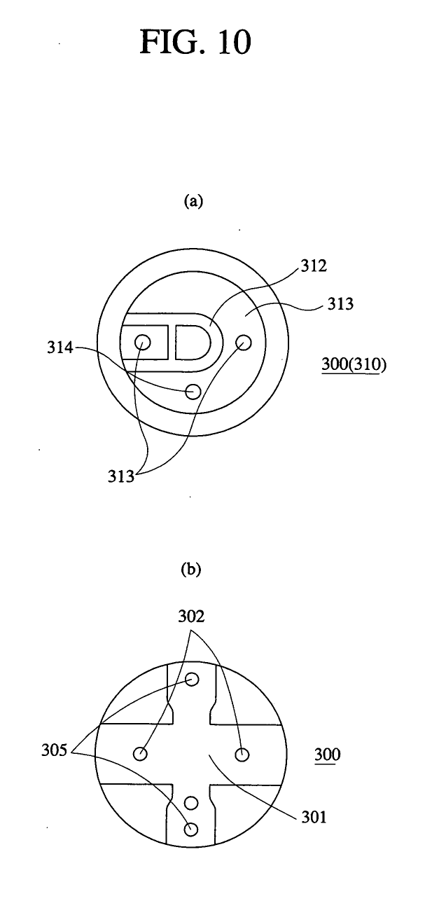

FIG. 7 is a perspective view showing an electric bulb socket according to a second exemplary embodiment of the present invention. FIG. 8 is a perspective view showing a disassembled state of an electric bulb socket according to the second exemplary embodiment of the present invention. FIGS. 9A through 9C are a cross-sectional view, a plan view and a bottom view of a connection unit of an electric bulb socket according to the present invention, respectively. FIGS. 10A and 10B are a bottom view and a plan view showing a socket body of an electric bulb socket according to the present invention, respectively.

Referring to FIGS. 7 through 10B, an electric bulb socket according to the present invention includes a socket body 300 and a connection unit 400, largely. Elastic pieces 430, fixed conductive pieces 440, and ground conductive pieces 450 are provided in the inner portion of the connection unit 400, and are assembled with coupling members such as screw bolts 420 and eyelets 320. The lamp shade A is inserted into and attached to the connection unit 400 through an opening a and the bare wires a are inserted into and connected with the entrance portion 401.

The socket body 300 includes a screw socket 310 which is fixed with eyelets 320 together with terminal pieces 312 in the lower space 304, and a fixed recessed groove 301 with which the fixed conductive pieces 440 forming locking pieces 443 in the upper portion.

The socket body 300 is provided with fixing holes 302 through which eyelets 320 pass on the bottom of the recessed groove 301 which is combined with the connection unit 400, and engagement holes 305 which communicate with the engagement protrusions 410, in which the fixing holes 302 and the engagement holes 305 are coupled with screw bolts 420, respectively.

The recessed groove 301 of the socket body 300 has a cruciform shape on the whole so as to correspond to the engagement protrusions 410 of the connection unit 400.

The connection unit 400 is provided with an entrance portion 401 into and with which bare wires “a” are inserted and connected respectively, where the lower portion of the connection unit 400 is opened, and elastic pieces 430 are inserted and supported in the inner side space 403 of the connection unit 400, and with locking grooves 402 by which the locking pieces 443 of the fixed conductive pieces 440 is locked so as to be inserted and attached therein in correspondence to the elastic pieces 430, in which the engagement protrusions 410 forming engagement holes 411 and 412 are formed in the middle of both sides of the connection unit 400.

In particular, the connection unit 400 is provided with three spaces 403 which are separately formed and the lower portion of which is opened, in which locking grooves 402 are formed in the inner wall of each space 403 and an entrance portion 401 is formed in the upper surface of each space 403 to communicate with each space 403, and locking elastic pieces 404 which prevent the engagement protrusion 410 from seceding at the time of combining the engagement protrusion 410 on the perpendicular planes of either side of the outer broad width is formed in parallel with the engagement protrusion 410, in which auxiliary protrusions 407 are formed in order to assist a fixed state of a lamp shade “A” which is fixed by the locking elastic pieces during assembly of the lamp shade “A”.

In addition, a locking portion 431 is slantingly formed in the upper portion of the elastic piece 430 so that the bare wires “a” are inserted and locked, a secession prevention locking piece 432 is formed on the perpendicular plane thereof, and a right angle plane is formed in the lower portion thereof.

In addition, the fixed conductive piece 440 is formed of an L-shaped form in which a locking piece 443 is formed on the perpendicular plane thereof, and fixing holes 442 are formed in the lower portion thereof which is bent at right angle.

Unlike the first exemplary embodiment of the present invention, an opening 405 which is cut open from the upper part of a central entrance portion 401 and an inserting and supporting groove 406 are connected and communicated with one of the engagement protrusions 410 and thus a ground connection conductive piece 450 forming an engagement hole 452 and a locking piece 453 is inserted and supported into the inserting and supporting groove 406.

Besides, a screw socket 310, a terminal piece 312, eyelets 320, and screw bolts 420 all of which are known form remainder fittings of the electric bulb socket according to the present invention.

The electric bulb socket according to the present invention will be assembled as follows.

As illustrated in the drawings, the screw socket 310 and the terminal piece 312 are located in the lower space 304 of the socket body 300, and the fixed conductive pieces 440 are located in the outer upper portion of the socket body 300. Then, the screw socket 310 and the terminal piece 312 are fixed through the eyelets 320 from the bottom of the socket body 300.

Here, the eyelets 320 pass through the third fixing holes 313, the second fixing holes 314, and the first fixing holes 442 in the fixed conductive piece 440 located on the bottom of the space 301 in turn, and then the top portions of the eyelets 120 protruded into the first fixing holes 342 are compressed to fix the eyelets 320.

Meanwhile, the connection unit 400 is provided with the locking portion 431 in the spaces 403. In addition, the elastic pieces 430 provided with the secession prevention locking pieces 432 formed of respective perpendicular planes are inserted into the middle portion of the spaces 403, and attached and supported thereto, so that the locking pieces 432 are locked into the locking grooves 402 in both sides of the central horizontal wall of the connection unit 400.

Likewise, if the internal assemblies of both the socket body 300 and the connection unit 400 are ended, the connection unit 400 is inserted into the upper space 301 of the socket body 300 to make the connection unit 400 combined with the socket body 300.

Here, the locking pieces 443 of the fixed conductive pieces 440 are inserted into and then locked by the empty locking grooves 402 in the spaces 403 of the connection unit 400. As a result, since the connection unit 400 and the fixed conductive pieces 440 are linked to each other in an integrated form, the socket body 300 and the connection unit 400 are integrally combined with each other.

In this way, the elastic pieces 430 and the fixed conductive pieces 440 are located face to face in each space 403, the bare wires “a” are inserted and closely attached to and supported by each other between the locking portion 431 and the fixed conductive pieces 440.

Thereafter, in order to combine the electric bulb socket with a lamp shade “A”, the other screw bolt 420 is engaged with and fixed to engagement holes 411 and 302, through a hole which is formed on the lamp shade “A”. Accordingly, the present invention provides a socket coupling structure integrated with the lamp shade “A”.

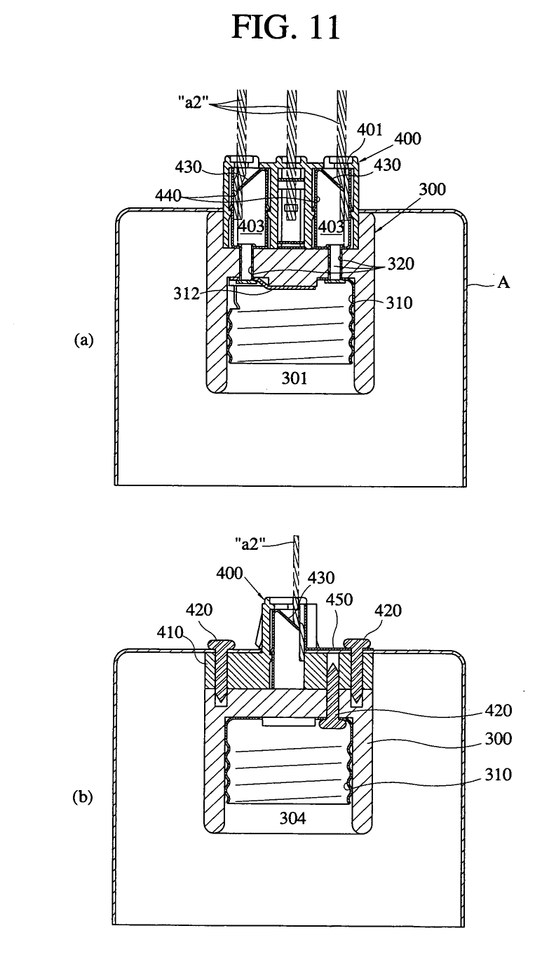

FIGS. 11A and 11B are cross-sectional views showing an electric bulb socket according to the present invention, respectively.

The function of the electric bulb socket according to the present invention will be described with reference to FIGS. 11A and 11B.

As illustrated in FIGS. 11A and 11B, bare wires “a” are inserted into the entrance portion 401 to then be inserted and supported between the fixed conductive pieces 440 and the locking portions 431 of the elastic pieces 430. Accordingly, an electric power supply voltage can be applied along the fixed conductive pieces 440. The electric power supply voltage applied through the fixed conductive pieces 440 is applied to the screw socket 310 and the terminal pieces 312 through the eyelets 320 to thus electrify the same, and accordingly supply an electric power voltage to an electric bulb which is screw-engaged with the electric bulb socket.

Thus, the present invention provides a new electric bulb socket having a bare wire connection unit different from that of the known electric bulb socket.

As described above, the present invention has an effect of simplifying connection and coupling of bare wires which are formed by peeling the end portion of the sheath electric wires, by improving a conventional sheathed electric wire connection structure of winding the bare wires around a bolt head at the rear end portion of the socket body and the eyelets bare wire in a ring style and connecting the same by tightening bolts.

The present invention employs a simple electric wire connection structure to thus provide a more stable power supply voltage. In particular, an assembly work of the electric bulb socket is speedily performed. Further, the electric bulb socket according to the present invention can be grounded from electric appliances which require grounded.

As described above, the present invention has been described with respect to particularly preferred embodiments. However, the present invention is not limited to the above embodiments, and it is possible for one who has an ordinary skill in the art to make various modifications and variations, without departing off the spirit of the present invention. Thus, the protective scope of the present invention is not defined within the detailed description thereof but is defined by the claims to be described later and the technical spirit of the present invention.

### INDUSTRIAL APPLICABILITY

As described above, the electric bulb socket according to the present invention can be widely used in various kinds of illumination fixture fields which are used as lamp shade lighting fixtures or overhead lighting fixtures.

What is claimed is:

1) An electric bulb socket comprising:
a socket body in the upper surface of which a recessed groove is formed; and
a connection unit which is inserted into and fixed to the recessed groove, and is provided with at least one entrance portion, in which elastic pieces are arranged and fixed in inner spaces thereof, and fixed conductive pieces respectively corresponding to the elastic pieces are arranged and fixed in the recessed groove, so as to be integrally combined with the socket body.

2) The electric bulb socket according to claim 1, wherein the socket body comprises a screw socket which is fixed with eyelets together with terminal pieces in the space.

3) The electric bulb socket according to claim 1, wherein the fixed conductive pieces form locking pieces, in which locking grooves which are locked with the locking pieces are formed in the spaces.

4) The electric bulb socket according to claim 1, wherein the connection unit further comprises engagement protrusions forming engagement holes.

5) The electric bulb socket according to claim 1, wherein locking elastic pieces for coupling a lamp shade (“A”) are formed in both side surfaces of the outer side of the connection unit.

6) The electric bulb socket according to claim 1, wherein the connection unit comprises three entrance portions in which the elastic pieces and the fixed conductive pieces are inserted into and supported to the inner spaces of both sides thereof, in correspondence to each other, and an opening and an inserting and supporting groove are formed in the central entrance portion through one side of which the inner portion thereof is communicated to reach the upper surface of the engagement protrusions, to thus make the elastic pieces and the fixed conductive pieces inserted into and supported to the inserting and supporting groove to then be fixed thereto.

7) The electric bulb socket according to claim 1, wherein seating grooves are further formed in the recessed groove of the socket body.

8) The electric bulb socket according to claim 1, wherein the socket body comprises a cruciform recessed groove so as to be coupled in correspondence to the connection unit.

9) The electric bulb socket according to claim 1, wherein the elastic pieces comprise slanted locking portions into which bare wires are elastically inserted in which secession prevention locking pieces are formed on the perpendicular plane thereof.

10) The electric bulb socket according to claim 1, wherein the fixed conductive pieces comprise an L-shaped form in which a locking piece is formed on the perpendicular plane thereof, and fixing holes are formed in the lower portion thereof which is bent at a right angle.

11) The electric bulb socket according to claim 1, wherein the engagement holes of the socket body and the engagement holes of the engagement protrusions are engaged and combined with screw bolts.

12) The electric bulb socket according to claim 1, wherein the socket body is cylindrical.

13) The electric bulb socket according to claim 1, wherein fixing holes through which the eyelets pass are formed at the bottom side of the recessed grooves.
